(19) United States
(12) Patent Application Publication
(10) Pub. No.: US 2011/0019019 A1
(43) Pub. Date: Jan. 27, 2011

(54) METHOD AND SYSTEM FOR PROCESSING PHOTOGRAPH IN CAMERA DEVICE

(75) Inventor: JUN LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/610,383

(22) Filed: Nov. 2, 2009

(30) Foreign Application Priority Data
Jul. 27, 2009 (CN) 200910304878.3

(51) Int. Cl. H04N 5/228; G06K 9/34

(52) U.S. Cl. 348/222.1; 382/173; 348/E05.031

(57) ABSTRACT

A method for processing photograph in a camera device, the method includes the following steps. A scene in view of the camera device is divided into at least two regions according to optimum exposure values for the two regions. A basic exposure value is set in the camera device, and an original photograph of the scene is taken at the basic exposure value. The original photograph is divided into at least two parts according to the at least two regions of the scene. Two optimum exposure values are set for the at least two parts of the original photograph respectively. The at least two parts of the original photograph are processed at the two corresponding optimum exposure values respectively. The at least two separately processed parts of the original photograph are combined together to produce a new photograph.

### BACKGROUND

1. Technical Field

The present disclosure relates to photography and, particularly, to a method and system for processing a photograph in a camera device.

2. Description of Related Art

In photography, exposure is the total amount of light allowed to fall on a photographic medium (photographic film or image sensor) when taking a photograph. Exposure is measured in lux seconds, and can be computed from exposure value and picture luminance over a specified area. A photograph may be described as overexposed when the bright parts of an image are effectively all white, known as “blown out highlights”. A photograph may be described as underexposed when the dark areas indistinguishable from black, known as “blocked up shadows”. A typical method for processing a photograph is to use an intermediate exposure value, which is still not so precise. Therefore there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a system for processing photographs in a camera device, in accordance with an embodiment.

FIG. 2 is a flow chart of a method for processing photograph in a camera device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

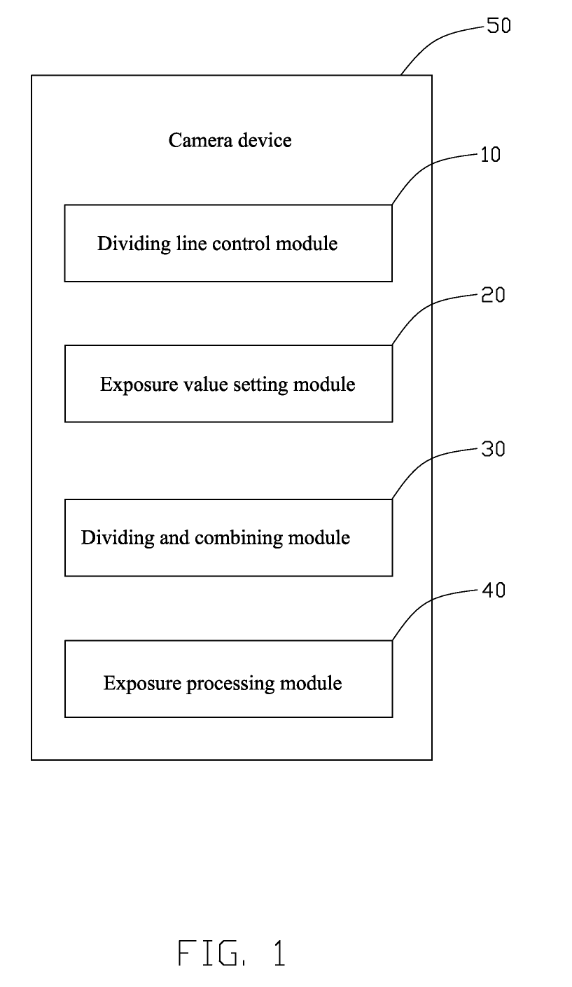

Referring to FIG. 1, a system for processing photograph in a camera device includes a dividing line control module 10, an exposure value setting module 20, a dividing and combining module 30, and an exposure processing module 40. The dividing line control module 10 is capable of dividing a scene in view of the camera device 50 into a plurality of regions according to optimum exposure values for the different regions. The dividing line control module 10 includes a plurality of dividing lines (not shown). The dividing line control module 10 controls the plurality of dividing lines to adjust demarcation of the regions of the scene in view of the camera device 50. The exposure value setting module 20 is capable of setting an optimum exposure value for each of the plurality of regions respectively. The dividing and combining module 30 is capable of dividing an original photograph of the scene into a plurality of parts according to the plurality of regions of the scene. The exposure processing module 40 is capable of processing each of the plurality of parts of the original photograph according to its optimum exposure values. The dividing and combining module 30 is capable of combining the plurality of separately processed parts of the original photograph together to produce a new photograph.

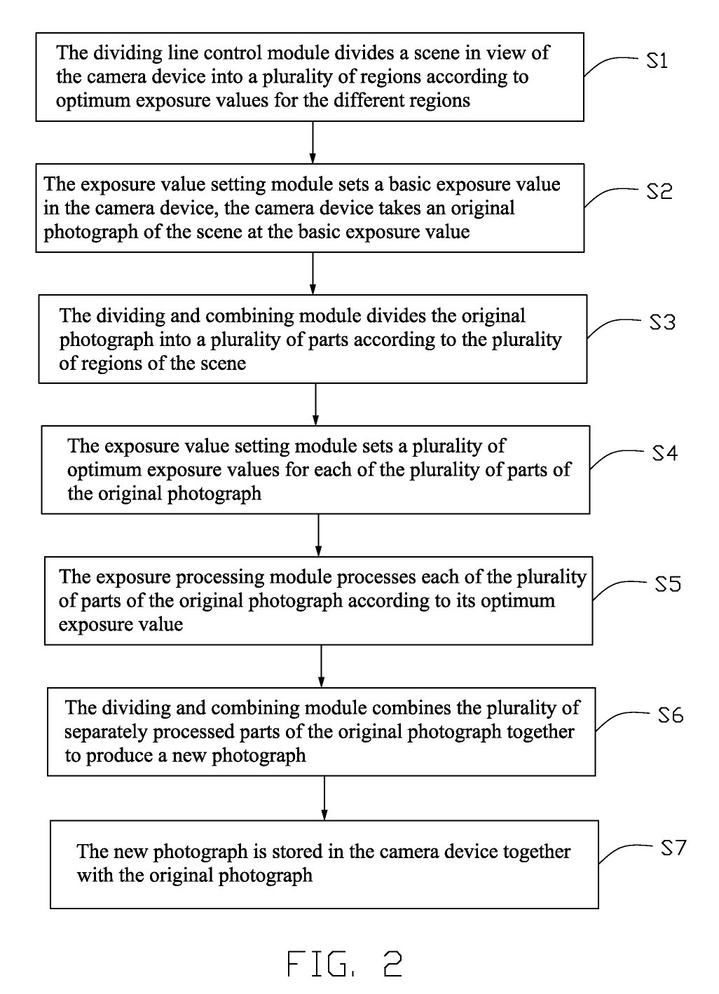

FIG. 2 is a flow chart illustrating a method for processing a photograph in a camera device. Depending on the embodiment, certain steps described below may be removed, while others may be added, and the sequence of the steps may be altered. In one embodiment, the method for processing the photograph in a camera device utilizing the above-described system includes the following steps:

S1: the dividing line control module 10 divides a scene in view of the camera device 50 into a plurality of regions according to optimum exposure values for the different regions;

S2: the exposure value setting module 20 sets a basic exposure value in the camera device 50, the camera device 50 takes an original photograph of the scene at the basic exposure value;

S3: the dividing and combining module 30 divides the original photograph into a plurality of parts according to the plurality of regions of the scene;

S4: the exposure value setting module 20 sets a plurality of optimum exposure values for each of the plurality of parts of the original photograph;

S5: the exposure processing module 40 processes each of the plurality of parts of the original photograph according to its optimum exposure value;

S6: the dividing and combining module 30 combines the plurality of separately processed parts of the original photograph together to produce a new photograph;

S7: the new photograph is stored in the camera device 50 together with the original photograph.

For example, when a user wants to take a photo of a high contrast scene, the view of the scene in the camera device 50 is divided into at least two regions according to optimum exposure values for the two regions. A basic exposure value is set in the camera device 50, and a photograph of the scene is taken at the basic exposure value to get an original photograph. The original photograph is divided into at least two parts according to the at least two regions of the scene. Two optimum exposure values are set for the at least two parts of the photograph respectively. The at least two parts of the photograph are then processed according to the two corresponding optimum exposure values respectively. At last, the at least two processed parts of the photograph are combined together to produce a new photograph. The new photograph is stored in the camera device 50 together with the original photograph. The two optimum exposure values comprise a first exposure value and a second exposure value, and the basic exposure value is between the first and second exposure values. In this embodiment, the basic exposure value is 1/1000 second, the first exposure value is 1/2000 second, the second exposure value is 1/500 second.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed. It is also to be understood that the above description and the claims drawn to a method may include some indication in reference to certain steps. However, the indication used is only to be viewed for identification purposes and not as a suggestion as to an order for the steps.

What is claimed is:

1. A method for processing photograph in a camera device, the method comprises the following steps:
dividing a scene in view of the camera device into at least two regions according to optimum exposure values for the two regions;
setting a basic exposure value in the camera device, and taking an original photograph of the scene at the basic exposure value;
dividing the original photograph into at least two parts according to the at least two regions of the scene;
setting two optimum exposure values for the at least two parts of the original photograph respectively;
processing the at least two parts of the original photograph at the two corresponding optimum exposure values respectively; and
combining the at least two separately processed parts of the original photograph together to produce a new photograph.

2. The method of claim 1, further comprising, after combining the at least two separately processed parts of the original photograph to produce a new photograph, storing the new photograph in the camera device together with the original photograph.

3. The method of claim 1, wherein the two optimum exposure values comprise a first exposure value and a second exposure value, the basic exposure value is between the first and second exposure values.

4. The method of claim 3, wherein the basic exposure value is 1/1000 second, the first exposure value is 1/2000 second, the second exposure value is 1/500 second.

5. A system for processing photograph in a camera device, comprising:
a dividing line control module configured for dividing a scene in view of the camera device into at least two regions according to optimum exposure values for the two regions;
an exposure value setting module configured for setting a basic exposure value in the camera device, the camera device takes an original photograph of the scene at the basic exposure value;
a dividing and combining module configured for dividing the original photograph into at least two parts according to the at least two regions of the scene; wherein the exposure value setting module sets two optimum exposure values for the at least two parts of the original photograph respectively; and
a exposure processing module configured for processing the at least two parts of the original photograph at the two corresponding optimum exposure values respectively; wherein the dividing and combining module combines the at least two separately processed parts of the original photograph together to produce a new photograph.

6. The system of claim 5, wherein the dividing line control module comprises a plurality of dividing lines for adjusting demarcation of the divided regions of the scene.

7. The system of claim 5, wherein the two optimum exposure values comprise a first exposure value and a second exposure value, the basic exposure value is between the first and second exposure values.

8. The system of claim 7, wherein the basic exposure value is 1/1000 second, the first exposure value is 1/2000 second, the second exposure value is 1/500 second.
